(19) United States
(12) Patent Application Publication
(10) Pub. No.: US 2015/0046177 A1
(43) Pub. Date: Feb. 12, 2015

(54) MEDICINE REGISTRATION APPARATUS AND PROGRAM

(71) Applicant: TOSHIBA TEC KABUSHIKI KAISHA, Tokyo (JP)

(72) Inventors: MAKOTO NOZAWA, Nagaizumi Shizuoka (JP); Yoshiaki Kumai, Mishima Shizuoka (JP); Yumiko Okuma, Nakano Tokyo (JP); Toshihide Murata, Izunokuni Shizuoka (JP); Shunichiro Kamamoto, Izunokuni Shizuoka (JP); Ryu Morita, Mishima Shizuoka (JP); Shiomi Matsui, Izunokuni Shizuoka (JP); Hirokazu Watanabe, Minato Tokyo (JP); Maki Sato, Yokohama Kanagawa (JP); Yasuhiro Nakajima, Izunokuni Shizuoka (JP)

(21) Appl. No.: 14/453,253

(22) Filed: Aug. 6, 2014

(30) Foreign Application Priority Data
Aug. 6, 2013 (JP) 2013-163634

(51) Int. Cl. G06F 19/00

(52) U.S. Cl. CPC G06F 19/326
USPC 705/2

(57) ABSTRACT

A medicine registration apparatus includes a storage unit, a processor and a display unit. The storage unit stores a medicine master database including information regarding a required disposal method of a medicine. The processor reads identification information on a medicine, identifies a medicine based on the identification information, determines whether the identified medicine includes a corresponding required disposal method in the medicine master database, and provide a notification that the identified medicine includes the corresponding requited disposal method when it is determined that the identified medicine includes the corresponding required disposal method. The display unit displays the notification.

### CROSS-REFERENCE TO RELATED APPLICATION

This application is based upon and claims the benefit of priority from Japanese Patent Application No. 2013-163634, filed Aug. 6, 2013, the entire contents of which are incorporated herein by reference.

### FIELD

Embodiments described herein relate to a medicine registration, apparatus and a program.

### BACKGROUND

In the related art, some systems are proposed to prevent medicine handling errors. For example, medicine information may be specified by a bar code applied to a container of a medicine to be injected. Information that the medicine should be injected is compared to the information specified by the bar code, and thus a misuse of the medicine is prevented.

In an operating room after a surgery, a nurse gathers empty containers of medicine used during the surgery. The nurse manually writes a total of the used medicines in a manifest, and submits the manifest to a medical professions division. Therefore, a method for recording the used medicine is known.

However, when the used medicine is recorded, it is not necessary to read a detailed explanation—such as a label of the empty container—upon discarding the empty container of the medicine. For this reason, the nurse may mistakenly record and then discard the medicine as general waste.

### DESCRIPTION OF THE DRAWINGS

FIG. 1 is a block diagram illustrating a configuration of a medicine management system according to an embodiment.

FIG. 2 is a front view illustrating an external appearance of a medicine registration apparatus.

FIG. 3 is a block diagram illustrating a hardware configuration of the medicine registration apparatus,

FIG. 4 illustrates an example of a data format of a medicine master database.

FIG. 5 is a block diagram illustrating a functional configuration of the medicine registration apparatus.

FIG. 6 illustrates a used medicine manifest on which medicine information is printed.

FIGS. 7A and 7B are flowcharts illustrating a sequence of operations for a used medicine registration process which is performed by an MPU of the medicine registration apparatus according to a control program.

FIG. 8 illustrates an example of a medicine registration start screen.

FIGS. 9A and 9B illustrate an example of a manual input screen.

FIG. 10 illustrates an example of a warning screen.

FIG. 11 illustrates an example of a medicine registration screen.

### DETAILED DESCRIPTION

According to an embodiment, a medicine registration apparatus and a program prevent medicine from being discarded as general waste, when the medicine should instead foe sorted and disposed of properly.

In general, according to one embodiment, a medicine registration apparatus includes a storage unit, a processor and a display unit. The storage unit stores a medicine master database including information regarding a required disposal method of a medicine. The processor reads identification information on a medicine, identifies a medicine based on the identification information, determines whether the identified medicine includes a corresponding required disposal method in the medicine master database, and provide a notification that the identified medicine includes the corresponding required disposal method when it is determined that the identified medicine includes the corresponding required disposal method. The display unit displays the notification.

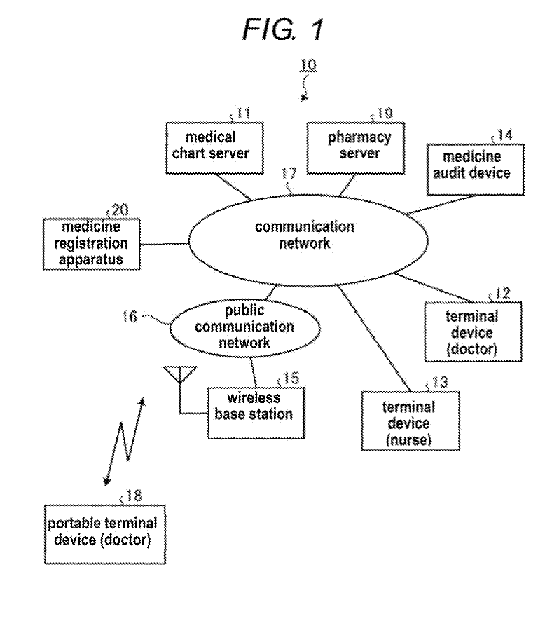

FIG. 1 is a block diagram illustrating a configuration of a medicine management system 10 according to an embodiment. As illustrated in FIG. 1, the medicine management system 10 includes a medical chart server 11, an information processing terminal device (for doctor) 12, an information processing terminal device (for nurse) 13, a medicine audit device 14, a pharmacy server 19, a medicine registration apparatus 20, and a portable information processing terminal device (for doctor) 18 which is connected to a communication network 17 through a wireless base station 15 and a public communication network 16.

The medical chart server 11 manages and stores electronic medical charts. The information processing terminal device (for doctor) 12 is a device for writing in and otherwise adding data to the electronic medical chart. The information processing terminal device (for nurse) 13 is a device for referring to and confirming the electronic medical chart which is managed by the electronic medical chart server 11. The medicine audit device 14 is a device for assisting and auditing preparation of a medicine or the like, based on instruction information (for example, prescription information) included in the electronic medical chart. The pharmacy server 19 is disposed in the pharmacy and manages dispensing medicine and the like. In addition, the pharmacy server 19 registers medicine information (a name, an amount, or the like) for the medicine in association, with code information of the medicine or external surface information of the medicine (e.g., a label of the medicine, a color shade of the medicine or a condition of a surface of the medicine such as a surface roughness, or the like). The medicine registration apparatus 20 is disposed in an operating room and assists with registration of a medicine by a nurse when the medicine is used during a surgery. The medicine registration apparatus 20 may also assist with registration of a medicine by a nurse, a pharmacist, or the like when the medicine is used in an emergency situation or the like. In this embodiment, it is assumed that the medicine registration apparatus 20 is disposed in the operating room, and is used for assisting with registration by the nurse when the medicine used during the surgery.

In the configuration described above, the electronic medical chart server 11, the information processing terminal device 12, the information processing terminal device 13, the medicine audit device 14, the pharmacy server 19, and the medicine registration apparatus 20 are connected to the communication network 17.

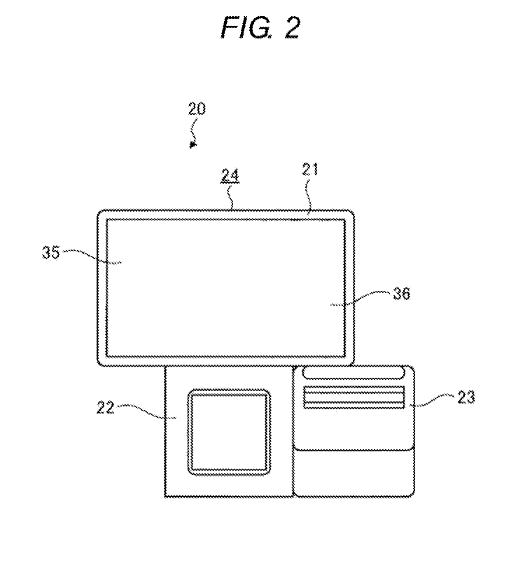

FIG. 2 is a front view of the medicine registration apparatus 20. As illustrated in FIG. 2, the medicine registration apparatus 20 generally includes an apparatus main body portion 24 which controls the medicine registration apparatus 20, a scanner 22, and a printer 23 for printing out various information items.

The apparatus main body portion 24 includes a touch panel display 21 which allows a nurse or other operator to perform various operations. The touch panel display may also display various information items such as a list of the used medicines.

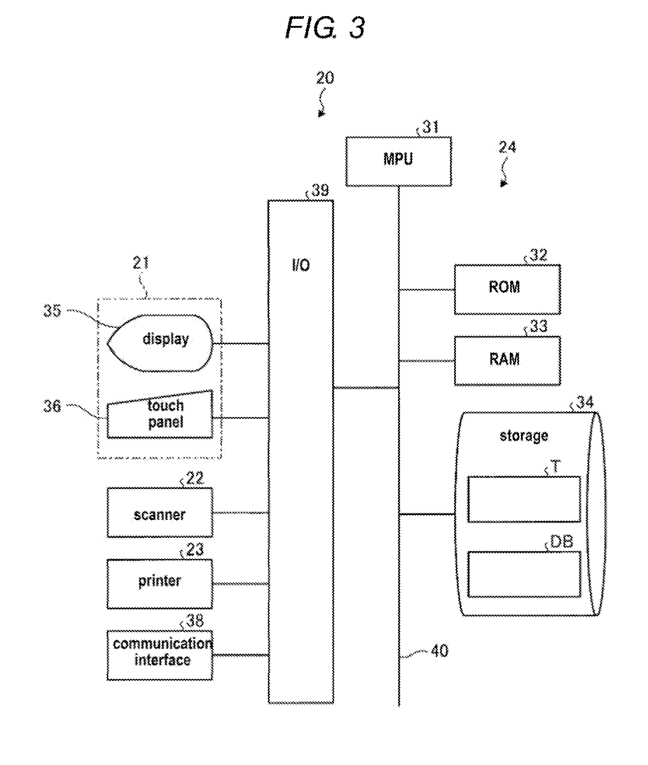

The scanner 22 includes an image sensor such as a color Charge Coupled Device (CCD) image sensor or a color Complementary Metal-Oxide Semiconductor (CMOS) image sensor, and a light source such as a Light Emitting Diode (LED). The scanner 22 captures images of, for example, a nurse Identification (ID), a patient ID, a code for the medicine, an image of the medicine, or the like. Images (captured images) may be sequentially captured by the scanner 22 at a predetermined frame rate. Images captured by the scanner 22 are stored in a Random Access Memory (RAM) 33 (refer to FIG. 3) described later.

Furthermore, the scanner 22 is not limited to a configuration in which the scanner 22 is disposed on a table, as illustrated in FIG. 2, For example, the scanner 22 may include a stand configuration disposed on a floor.

In addition, the medicine registration apparatus 20 may include a Radio Frequency Identification (RFID) reader and writer which performs data reading and writing with respect to a scale for measuring a weight of a medicine, or with respect to a RFID applied to a medicine, or the like.

FIG. 3 is a block diagram illustrating a hardware configuration of the medicine registration apparatus 20. As illustrated in FIG. 3, in the apparatus main body portion 24 of the medicine registration apparatus 20, a Micro Processing Unit (MPU) 31 which controls the entire apparatus, a Read Only Memory (ROM) 32, a RAM 33, an external storage device 34, and a communication interface (I/F) 38 which performs a communication interface operation are provided. The ROM 32 stores various data items including a control program in a non-volatile way. The RAM 33 functions as a work area, and temporarily stores the various data items. The external storage device 34 is configured with a hard disk drive or a Solid State Drive (SSD), which is able to store bulk data such as a database or the control program.

Here, the touch panel display 21, the scanner 22, the printer 23, and the communication interface 38 are connected to a bus 40 through an input and output I/O 39. The MPU 31, the ROM 32, the RAM 33, and the external storage device 34 are connected to the bus 40.

Furthermore, the touch panel display 21 is mainly provided with a display 35, and a touch panel 36. The display 35 and touch panel 36 may be integrated in a touch-screen display.

In addition, the external storage device 34 is provided with a used medicine storage table T, and a medicine master database. The used medicine storage table T stores a total of the used medicine.

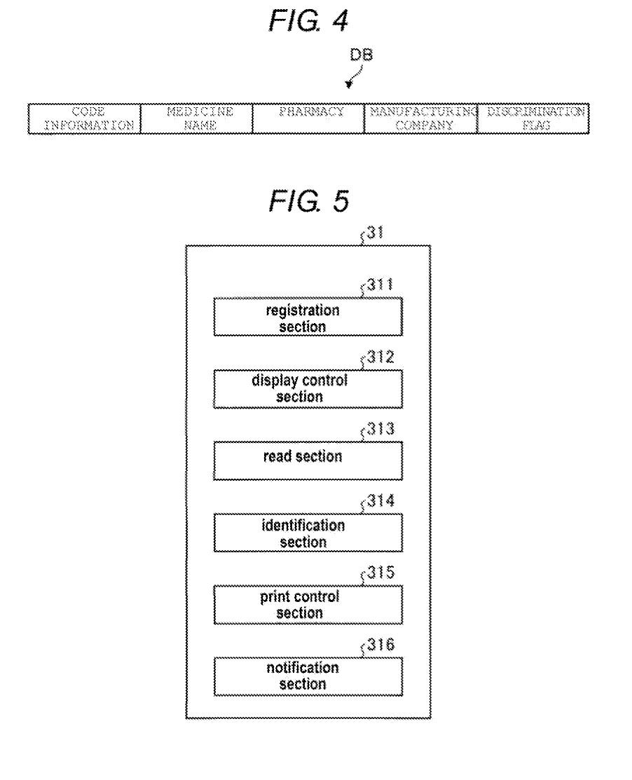

The medicine master database is a medicine database in which medicine information, including information regarding a disposal method of the medicine, is stored. Here, FIG. 4 illustrates an example of a data format of the medicine master database. The medicine master database stores code information, a medicine name, a pharmacy, a manufacturing company, and a sorting flag in association with each other.

The code information is an identifier for identifying the medicine. For example, the code information is a number applied to the bar code. Alternatively, for example, the code information maybe the external surface information on the medicine, or the like. The medicine name is a designation of the medicine. The pharmacy indicates a standard amount of the medicine. The manufacturing company indicates a company which manufactures the medicine. The sorting flag is information of the disposal method of the medicine. Specifically, the sorting flag is, for example, a flag which indicates whether or not a disposal method of a target medicine is determined. The sorting flag is valid when the disposal method is determined. On the other hand, the sorting flag is invalid when the disposal method is not determined.

Further, in detail, the medicine or an empty container of the medicine may have to be sorted and discarded according to a type of the medicine. For example, infectious waste and non-infectious waste must be disposed of differently from each other. The infectious waste is discarded by performing sorting such as division into bags. Then, the waste generator is responsible for properly processing the sorted infectious waste. Thus, most medical agencies entrust the disposal process to an external specialized service company.

According to the above-described configuration, the MPU 31 of the medicine registration apparatus 20 executes the control program stored in the ROM 32 or the external storage device 34, and thus assists the registration of the used medicine.

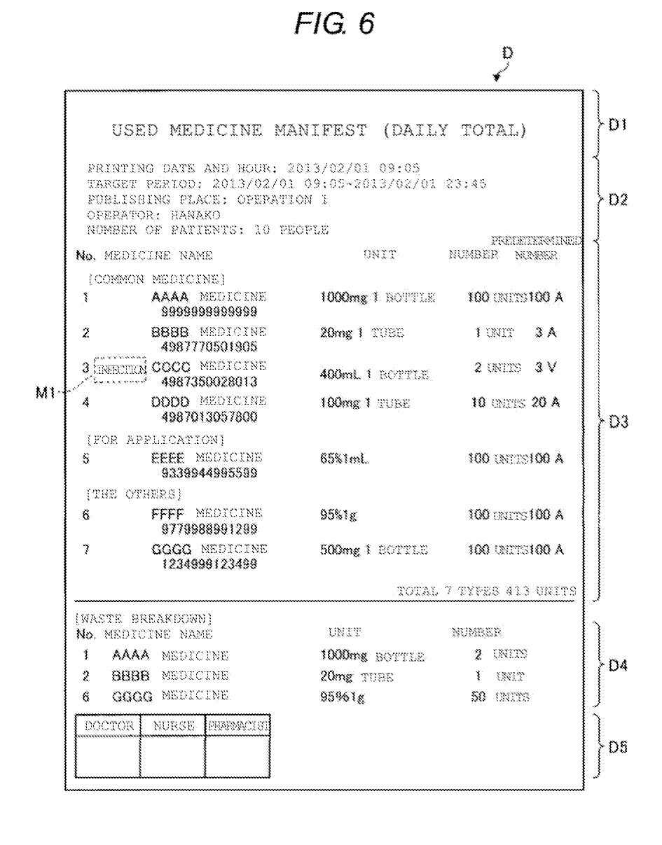

Next, a characteristic function of the medicine registration apparatus 20 according to the embodiment will be described. FIG. 5 is a block diagram illustrating a functional configuration of the medicine registration apparatus 20. The MPU 31 executes the control program stored in the ROM 32 or the external storage device 34, and thus functions as a registration section 311, a display control section 312, a read section 313, an identification section 314, a print control section 315, and a notification section 316, as illustrated in FIG. 5.

The read section 313 reads out the identifier of the medicine from the captured image scanned by the scanner 22. Specifically, the read section 313 reads out the code information from, the code symbol, applied to a medicine to be used or the external surface information of an entirety or a part of a medicine to be used. A process for detecting the code information from the code symbol such as a bar code or a two-dimensional code is known in the related art; accordingly, the detailed, description thereof will foe omitted.

The identification section 314 identifies the medicine based on the information (the code information or the external surface information) obtained as a reading result in the read section 313, and extracts the medicine information. Specifically, the identification section 314 identifies the medicine by retrieving the code information read, out by the read section 313 from the medicine master.

In addition, a method tor identifying the medicine based on the external surface information of the medicine may be such that the external surface information of the medicine is associated with the code information and stored as a table in advance, and the medicine information of the medicine is extracted from the table based on the external surface information.

The registration section 311 registers the medicine identified by the identification section 314 in the used medicine storage table T of the external storage device 34.

The display control section 312 controls a display of the medicine information identified by the identification section 314 on the display 35 (display unit).

The print control section 313 controls the printer 23 (print unit) to print the medicine information identified by the identification section 314.

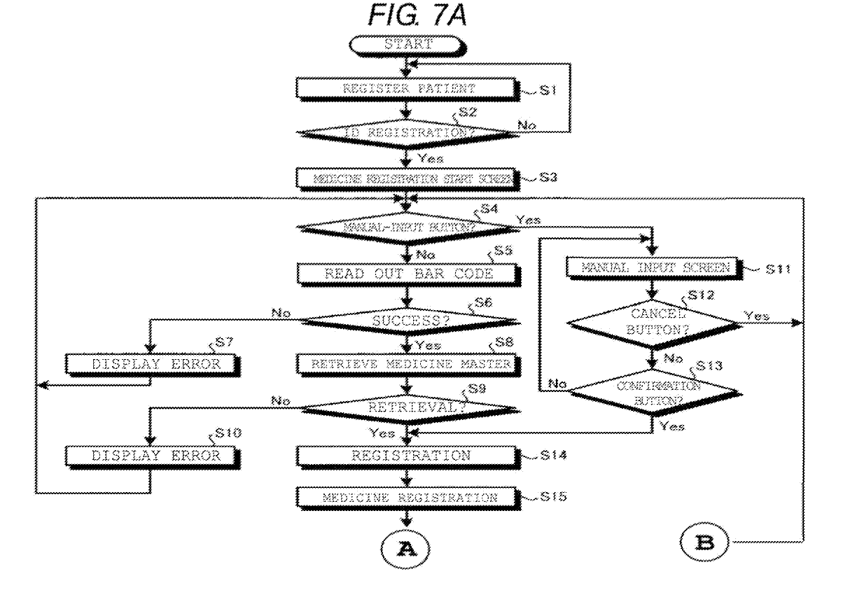

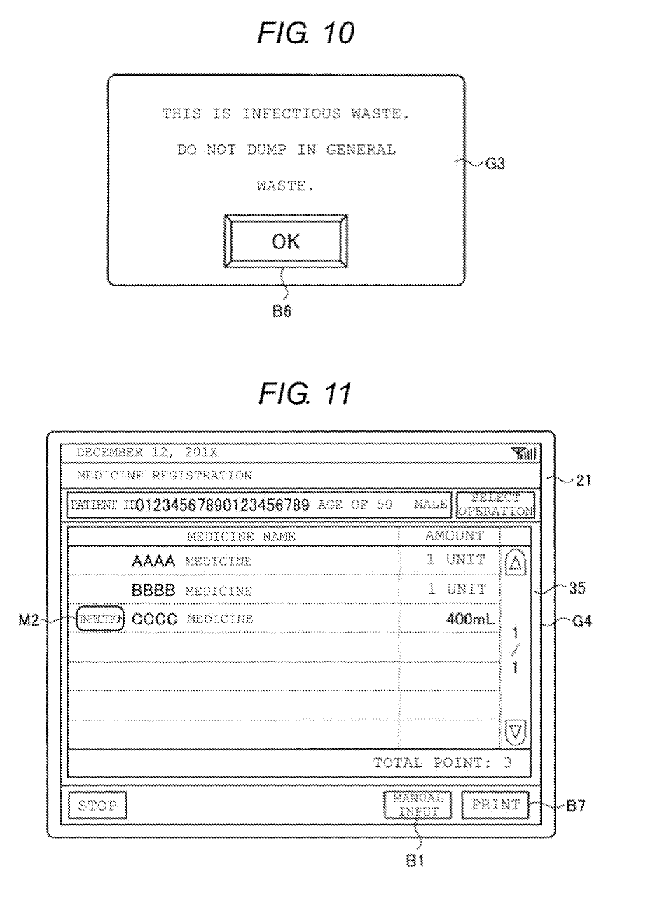

When a medicine has a valid sorting flag—i.e., a medicine having a determined, a disposal method—is identified by the identification section 314, the notification section 316 provides notification that the disposal method is determined. A notification, is performed by various methods. For example, the notification section 316 performs the notification by allowing the display control section 312 to display a screen on which a reason for requiring sorting is displayed. Alternatively, the notification section 316 performs the notification try adding an infection mark M2 (refer to FIG. 11) to the display control, section 312 to be emphatically displayed. Alternatively, the notification section 316 performs the notification by adding an infection mark. M1 (refer to FIG. 6) to the print control section 315 to be printed with emphasis. Alternatively, the notification section 316 performs the notification by making the warning sound such as buzzer sound from the speaker 37, for example, for about 3 seconds.

Here, FIG. 6 illustrates a used medicine manifest D on which medicine information is printed. The used medicine manifest D includes a list of the medicines registered in the used medicine storage table T, as illustrated in FIG. 6. The used medicine manifest D includes a header D1, basic information D2, used medicine data D3, waste data D4, and an approval seal section D5. The header D1 is a region on which a manifest title is printed. The basic information D2 is a region on which a printing date and hour, a target period, a publishing place, an operator, and the number of patients are printed.

The used medicine data D3 includes: a number (“No.”) line, a medicine name line, a unit line, a used number line, and a predetermined number line. On the number (“No.”) line, a sort name and an item, number are included. The sort name is a title of medicine sorting. In addition, each medicine is listed in order of the sort name. The item number is a set of numbers which is applied to each medicine type.

On the medicine name line, a medicine name, the infection mark M1, and a code number of the medicine are printed. The medicine name is a designation of the medicine. The infection mark M1 is displayed when the sorting flag of the medicine master database is valid. In addition, when the sorting flag is valid, the medicine name is printed in bold typeface. Thus, it is possible to promote awareness of the special handling requirements of the used medicine, by printing the infection mark M1, printing the medicine name in bold typeface, or the like.

Furthermore, when the infection mark M1 is printed, an emphasized display of the medicine name may be emphasized by changing a displayed color. Alternatively, the display of the medicine name may be emphasized by changing a font or a size of the medicine name.

The code number of the medicine is a number applied to the code symbol of the medicine. FIG. 6 illustrates a state where the sorting flag of a medicine name “CCCC medicine” is valid, and the infection mark M1 is printed.

As illustrated in FIG. 6, the unit line indicates a criterion for a used amount of the target medicine. The used number line indicates a used amount of the target medicine. The predetermined number line indicates a regular amount of the target medicine. Accordingly, the pharmacy performs restocking of the medicine, or the like. The waste data D4 is a region which lists discarded medicine. The approval seal section D5 is a region which includes a section for affixing an approval seal.

Next, a used medicine registration process which is performed by the MPU 31 of the medicine registration apparatus 20 of the embodiment described above according to the control program will be described. The medicine registration apparatus 20 according to the embodiment scans the code symbol on the used medicine, the medicine image, or the like, and performs the medicine registration process.

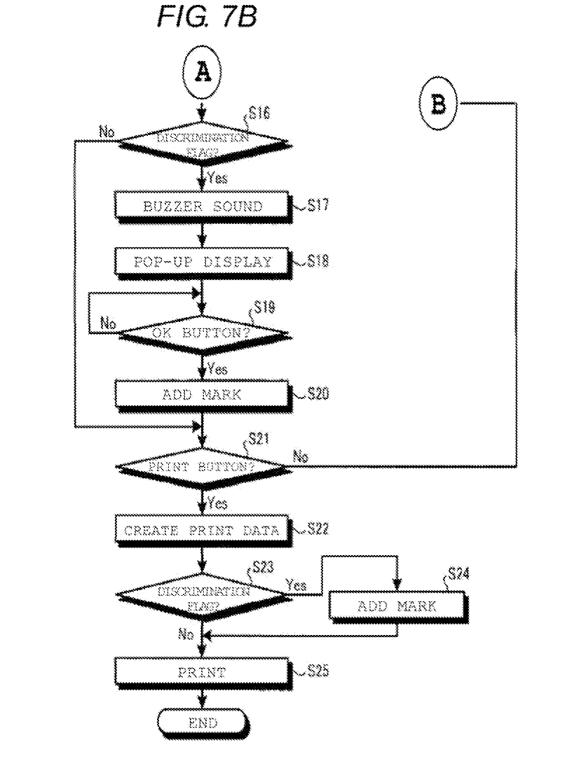

FIGS. 7A and 7B are flowcharts illustrating a sequence of operations for the used medicine registration process which is performed by the MPU 31 of the medicine registration apparatus 20 according to the control program.

The MPU 31 of the medicine registration apparatus 20 displays a patient registration screen on. the display 35, as an initial state (Step S1). Therefore, in order to perform the patient registration process, an operator (a nurse) holds the patient ID on a wristband of the patient to the front of the scanner 22, and reads the patient ID.

When the patient ID is registered by the patient registration process (Step S2; Yes), the MPU 31 of the medicine registration apparatus 20 displays a medicine registration start screen G1 on the display 35 (Step S3). Furthermore, when the MPU 31 of the medicine registration apparatus 20 is not able to register the patient ID (Step 52; No), the MPU 31 returns to Step S1, and the patient registration screen is displayed again.

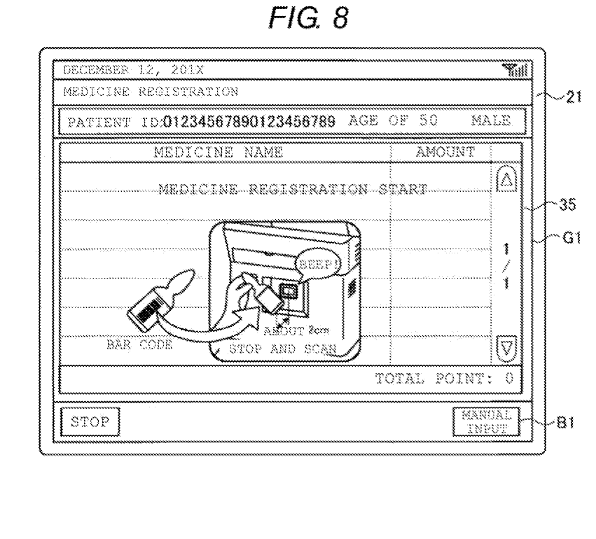

FIG. 8 illustrates an example of the medicine registration start screen G1. The medicine registration start screen G1, as illustrated in FIG. 8, displays how the code symbol of the medicine is read out. In addition, the medicine registration start screen G1 is provided with a manual-input button B1. The manual-input button B1 is a button which is pressed when a numeric character applied to the code symbol of the medicine is registered by a manual input.

When the operator holds the medicine to the front of the scanner 22 without pressing the manual-input button B1 (Step S4; No), the MPU 31 of the medicine registration apparatus 20 reads out the code symbol. (Step S5). The MPU 31 of the medicine registration apparatus 20 determines whether or not the code symbol is successfully read out (Step S6). When the code symbol is not successfully read out (Step S6; No), the MPU 31 of the medicine registration apparatus 20 displays an error, and returns to Step S4 (Step S7).

When the code symbol is successfully road out (Step S6; Yes), the MPU 31 of the medicine registration apparatus 20 retrieves the code information corresponding to the code symbol from the medicine master database (Step S8). The MPU 31 of the medicine registration apparatus 20 determines whether or not the code information is successfully retrieved (Step S9). When the code information is not successfully retrieved from the medicine master database (Step S9; No), the MPU 31 of the medicine registration apparatus 20 displays the error, and returns to Step S4 (Step S10).

When the code information, is successfully retrieved from the medicine master database (Step S9; Yes), the MPU 31 of the medicine registration apparatus 20 registers contents of the medicine master database in the used medicine storage table T (Step S14).

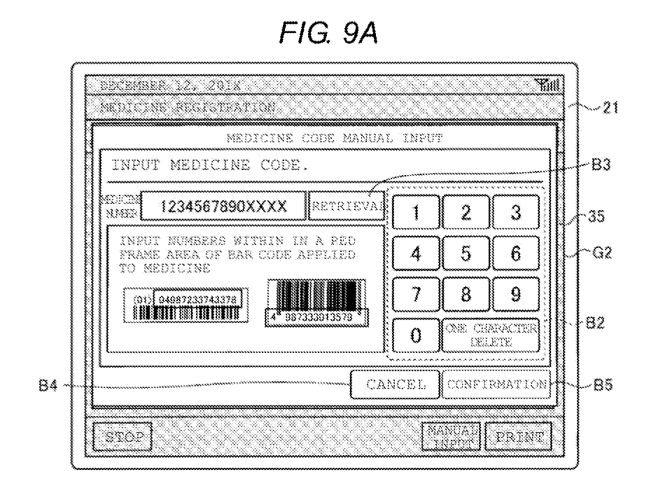

Returning to FIG. 8, when the manual-input button B1 is pressed (Step S1; Yes), the MPU 31 of the medicine registration apparatus 20 displays a manual input screen G2 (Step S11). FIGS. 9A and 9B Illustrate an example of a manual input screen G2. FIG. 9A illustrates the manual input screen G2 before retrieving. In FIG. 9A, an instruction such as “Input medicine code” is displayed, and input of the code symbol is required. FIG. 9B illustrates the manual input screen G2 after performing the retrieving. In FIG. 9B, an instruction such as “Confirm medicine” is displayed, and confirmation of the medicine from a candidate list corresponding to a retrieval condition is required. In addition, as illustrated in FIG. 9, the manual input screen G2 includes a numeric character button B2, a retrieval button S3, a cancel button B4, and a confirmation button B5.

The numeric character button B2 is used for inputting the code symbol. The numeric character button S2 is provided with numeric characters from 0 to 9, and a one character delete button used when a character is input incorrectly. The retrieval button B3 is used after inputting the input number to initiate retrieval of the medicine including the code information coincident with the input number. When the retrieval, button B3 is pressed, the MPU 31 of the medicine registration apparatus 20 displays the manual input screen G2 after performing the retrieving.

The cancel, button B4 is used, to stop the manual input. The confirmation button B5 is used to confirm the retrieved medicine. When the cancel button B4 is pressed (Step S12; Yes), the MPU 31 of the medicine registration apparatus 20 erases the manual input screen G2, and returns to Step S4. When the cancel button B4 is not pressed (Step S12; No), and the confirmation button S5 is not pressed (Step 313; No), the MPU 31 of the medicine registration apparatus 20 returns to Step S11, and continues to display the manual input screen G2. When the confirmation button B5 is pressed (Step S13; Yes), the MPU 31 of the medicine registration apparatus 20 erases the manual input screen G2, then proceeds to Step S14, and registers the contents in the used medicine storage table T (Step S14).

Next, the MPU 31 of the medicine registration apparatus 20 displays the contents registered in the used medicine storage table T on a medicine registration screen G4 (refer to FIG. 11) (Step S15). Next, the MPU 31 of the medicine registration apparatus 20 determines whether or not the sorting flag is valid (Step S16).

When the sorting flag is invalid (Step S16; No), the MPU 31 of the medicine registration apparatus 20 proceeds to Step S21.

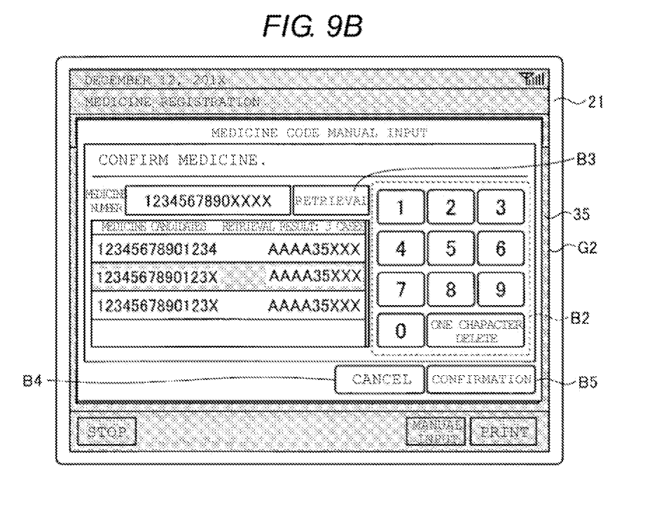

On the other hand, when the sorting flag is valid (Step S16; Yes), the MPU 31 of the medicine registration apparatus 20 provides a notification that the medicine should not be discarded as general waste by making buzzer sound as the warning sound (Step S17). Next, the MPU 31 of the medicine registration apparatus 20 displays a pop-up warning screen G3 (Step S18). FIG. 10 illustrates an example of a warning screen G3. The warning screen G3 provides a notification that the medicine is required to be sorted and handled properly. Then, the warning screen G3, as illustrated in FIG. 10, displays an instruction such as “This is infectious waste. Do not dump in general waste”. Accordingly, the medicine registration apparatus 20 draws the operator's (the nurse's) attention about the disposal method. In addition, the warning screen G3, as illustrated in FIG. 10, includes an OK button B6.

When the OK button B6 is not pressed (Step S19; No), the warning screen G3 is continuously displayed. When the OK button B6 is pressed (Step S19; Yes), the MPU 31 of the medicine registration apparatus 20 displays the medicine registration screen G4 with the infection mark M2 added thereto (Step S20). Here, FIG. 11 illustrates and example medicine registration screen G4. The medicine registration screen G4, as illustrated in FIG. 11, displays a list of the medicines that are registered in the used medicine storage table T. The medicine registration screen G4 includes a manual-input button B1, and a print button B7. FIG. 11 illustrates a state where the infection mark M2 is added to the CCCC medicine.

The MPU 31 of the medicine registration apparatus 20 determines whether or not the print button B7 is pressed (Step S21). When the print button B7 is not pressed (Step S21; No), the MPU 31 of the medicine registration apparatus 20 returns to Step S4. When the print button B7 is pressed (Step S21; Yes), the MPU 31 of the medicine registration apparatus 20 creates print data (Step S22).

Next, the MPU 31 of the medicine registration apparatus 20 determines whether or not medicine having the sorting flag as valid is included in the used medicine storage table T (Step S23). When the medicine with the sorting flag as valid is not included (Step S23; No), the MPU 31 of the medicine registration apparatus 20 proceeds to Step S25. When the medicine with the sorting flag as valid is included (Step S23; Yes), the MPU 31 of the medicine registration apparatus 20 adds the infection mark Ml to the print data (Step S24).

Next, the MPU 31 of the medicine registration apparatus 20 allows the printer 23 to print by using the print data (Step S25).

As described above, according to this embodiment, the medicine master database includes the sorting flag which indicates whether or not the medicine is able to be discarded as the general waste. When the medicine with the sorting flag as valid is detected, the notification section 316 performs the notification. Therefore, it is possible to prevent waste that is required to be sorted from being missed, and from being discarded as general waste.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit, of the inventions.

Furthermore, in the embodiment described above, a case which is used for assisting the registration of the medicine used during the surgery by the nurse is assumed and described. The notification that the disposal method is determined is not limited to assisting the registration of the medicine used during the surgery by the nurse. For example, when an audit task to determine whether or not the medicines gathered according to an instruction of the doctor are gathered without excess or deficiency is performed, the notification may be performed upon discarding the medicine. Specifically, when a reason for disposal, is generated in an entirety or a part of the gathered, medicine after completing the instructed medicine preparation, the medicine preparation is performed again. At this time, when the medicine for which the disposal method is determined is included in the medicine to be discarded, the notification that the disposal method is determined may be performed.

Alternatively, when the medicine is not used, but the medicine is discarded for a reason such as container breakage, the notification, that the disposal method is determined may be performed.

Furthermore, in the embodiment described above, a case where the code information is read out from the code symbol such as the bar code or the two-dimensional code applied to the medicine is described, but the code information may be information other than the code symbol. For example, the code information may be code information read out from a RFID or the like. In such a scenario, a RFID reader and writer or the like may be provided.

Furthermore, in the embodiment described above, although a case where the patient ID is input is described in the flowchart, it is not required to input the patient ID. Accordingly, it is possible to immediately perform the operation even when an urgent patient is carried in.

Furthermore, in the embodiment described above, a case where the infection mark M2 is added to the medicine registration screen G1 to be displayed with emphasis is described. However, the method for emphasizing the display is not limited thereto. For example, the display may be emphasized by displaying with a bold typeface, changing colors, blinking, displaying with an animation, changing background colors, or the like.

Furthermore, in the embodiment described above, a case where the notification is performed by making the warning sound such as the buzzer sound when there is infectious industrial waste is described. However, the warning sound is not limited thereto. For example, the notification that there is infectious industrial waste may be performed by voice recording or voice synthesis.

In addition, the program which is executed by the respective devices of the embodiment described above is provided by being stored on a storage medium (a ROM or a storage unit) provided in the respective devices in advance, but it does not limited thereto, and may be configured to be provided in a file format capable of being installed or executed, by being recorded on a recording medium, such as a CD-ROM, a Flexible Disk (FD), a CD-R, or a Digital Versatile Disk (DVD) which is readable in a computer. Further, the storage medium is not limited to a medium separated from the computer or an assembly system, and includes a storage medium which stores or temporarily stores a program transmitted through a LAN, the Internet, or the like by downloading the program.

In addition, the program which is executed by the respective devices of the embodiment described above may be configured to be stored on the computer connected to a network such as the Internet, and be provided by being downloaded through the network, or may be configured to be provided or distributed through the network such as the Internet.

What is claimed is:

1. A medicine registration apparatus, comprising:
a storage unit configured to store a medicine master database including information regarding a required disposal method of a medicine;
a processor configured to read identification information on a medicine, identify a medicine based on the identification information, determine whether the identified medicine includes a corresponding required disposal method in the medicine master database, and provide a notification that the identified medicine includes the corresponding required disposal method when it is determined that the identified medicine includes the corresponding required disposal method; and
a display unit configured to display the notification.

2. The medicine registration apparatus according to claim 1, wherein the identification information on the medicine is a code symbol applied to the medicine.

3. The medicine registration apparatus according to claim 1, wherein the identification information on the medicine is external surface information of the medicine.

4. The medicine registration apparatus according to claim 1, wherein the displayed notification includes a reason for the required disposal method discrimination.

5. The medicine registration apparatus according to claim 1, wherein:
the processor is further configured to control printing of list information including multiple medicines that are identified based on identification information that is read, and
when a medicine among the multiple identified medicines is determined to include a corresponding required disposal method, the notification includes printing the list information so that the medicine having the corresponding required disposal method is printed with emphasis.

6. The medicine registration apparatus according to claim 1, wherein:
the display unit is further configured to display list information including multiple medicines that are identified based on identification information that is read, and
the notification displayed on the display unit includes the medicine having the corresponding required disposal method being displayed with emphasis among the displayed list information.

7. The medicine registration apparatus according to claim 1, wherein the notification that the identified medicine includes the corresponding required disposal method includes a warning sound.

8. A method, for registering a medicine, the method comprising the steps of:
storing a medicine master database including information regarding a required disposal method of a medicine;
reading identification information on a medicine;
identifying a medicine based on the identification information;
determining whether the identified medicine includes a corresponding required disposal method in the medicine master database;
providing a notification that the identified medicine includes the corresponding required disposal method after it is determined that the identified medicine includes the corresponding required disposal method; and
displaying the notification.

9. The method according to claim 8, wherein the identification information on the medicine is a code symbol applied to the medicine

10. The method according to claim 8, wherein the identification information on the medicine is external surface information of the medicine.

11. The method according to claim 8, wherein the displayed notification includes a reason for the required disposal method discrimination.

12. The method according to claim 8, further comprising the step of:
printing list information including multiple medicines that are identified, based on identification information that is read, wherein
when a medicine among the multiple identified medicines is determined to include a corresponding required disposal method, the notification includes printing the list information so that the medicine having the corresponding required disposal method is printed with emphasis.

13. The method according to claim 8, further comprising the step of:
displaying list information including multiple medicines that are identified based on identification information that is read, wherein
the displayed, notification includes the medicine having the corresponding required disposal method being displayed with emphasis among the displayed list information.

14. The method according to claim 8, wherein the notification that the identified medicine includes the corresponding required disposal method includes a warning sound.

15. A non-transitory computer readable medium having instructions executable on a medicine registration apparatus having a storage device and processor, the instructions causing the medicine registration apparatus to perform the steps of:
storing, in the storage unit, a medicine master database including information regarding a required disposal method of a medicine;
reading identification information on a medicine;
identifying a medicine based on the identification information;
determining whether the identified medicine includes a corresponding required disposal method in the medicine master database;
providing a notification that the identified medicine includes the corresponding required disposal method after it is determined that the identified medicine includes the corresponding required disposal method; and
displaying the notification on a display screen.

16. The non-transitory computer readable medium according to claim 15, wherein the identification information on the medicine is one of a code symbol applied to the medicine and external surface information of the medicine.

17. The non-transitory computer readable medium according to claim 15, wherein the displayed notification includes a reason for the required disposal method discrimination.

18. The non-transitory computer readable medium according to claim 15, wherein the instructions cause the medicine registration apparatus to further perform the step of:
printing list information including multiple medicines that are identified based on identification information that is read, wherein
when a medicine among the multiple identified medicines is determined to include a corresponding required disposal method, the notification includes printing the list information so that the medicine having the corresponding required disposal method is printed with emphasis.

19. The non-transitory computer readable medium according to claim 15, wherein the instructions cause the medicine registration apparatus to further perform the step of:
displaying list information including multiple medicines that are identified based on identification information that is read, wherein
the displayed notification includes the medicine having the corresponding required disposal method being displayed with emphasis among the displayed list information.

20. The non-transitory computer readable medium according to claim 15, wherein the notification that the identified medicine includes the corresponding required disposal method includes a warning sound.
